(19) United States
(12) Patent Application Publication
(10) Pub. No.: US 2025/0361575 A1
(43) Pub. Date: Nov. 27, 2025

(54) SOFT MAGNETIC ALLOY AND METHOD FOR PRODUCING SOFT MAGNETIC ALLOY

(71) Applicant: DAIDO STEEL CO., LTD., Nagoya-shi (JP)

(72) Inventors: Hiroyuki TAKABAYASHI, Nagoya-shi (JP); Takeshi HATTA, Nagoya-shi (JP); Chihiro FURUSHO, Nagoya-shi (JP)

(21) Appl. No.: 19/214,413

(22) Filed: May 21, 2025

(30) Foreign Application Priority Data
May 22, 2024 (JP) 2024-083191

(51) Int. Cl. C21D 9/00; C21D 1/74; C21D 6/00; C22C 38/00; C22C 38/02; C22C 38/04; C22C 38/06; C22C 38/20; C22C 38/22; C22C 38/24; C22C 38/26; C22C 38/28; C22C 38/30; C22C 38/32; C22C 38/34; C22C 38/42; C22C 38/44; C22C 38/48; C22C 38/54; H01F 1/147

(52) U.S. Cl. CPC C21D 9/0068; C21D 1/74; C21D 6/002; C21D 6/004; C21D 6/005; C21D 6/007; C21D 6/008; C22C 38/001; C22C 38/002; C22C 38/004; C22C 38/02; C22C 38/04; C22C 38/06; C22C 38/20; C22C 38/22; C22C 38/24; C22C 38/26; C22C 38/28; C22C 38/30; C22C 38/32; C22C 38/34; C22C 38/42; C22C 38/44; C22C 38/48; C22C 38/54; H01F 1/14766; C21D 2201/03; C22C 2200/04; C22C 2202/02

(57) ABSTRACT

The present invention relates to a soft magnetic alloy including, in terms of at %: 7.0%≤Si≤12.0%; 7.0%≤B≤10.0%; 0.5%≤Cu≤2.0%; 0.5%≤P≤2.0%; and 3.0%<X≤5.0%, X being at least one element selected from the group consisting of Ti, Nb, V, Zr, Hf, Ta, and W, with the balance being Fe and unavoidable impurities, or being Fe, at least one selected from the group consisting of Ni with which a part of Fe is substituted and Co with which a part of Fe is substituted, and unavoidable impurities, in which the soft magnetic alloy satisfies 0.40≤Cu/P<1.0 where Cu and P represent the contents of Cu and P in terms of at %, respectively.

### CROSS-REFERENCE TO RELATED APPLICATIONS

This application is based on and claims priority under 35 USC 119 from Japanese Patent Application No. 2024-083191 filed on May 22, 2024, the entire content of which is incorporated herein by reference.

### TECHNICAL FIELD

The present invention relates to a soft magnetic alloy and a method for producing a soft magnetic alloy, and more particularly to a soft magnetic alloy including a Fe—Si—B—Cu—Nb alloy and a method for producing the same.

### BACKGROUND ART

As a kind of soft magnetic alloy used for a high-frequency transformer, a choke coil, a motor core, and the like, a material including a Fe—Si—B—Cu—Nb alloy is known. Such materials are disclosed in the following Patent Literatures 1 to 3 and the like. An alloy including a Fe—Si—B—Cu—Nb alloy is obtained in an amorphous state and then subjected to heat treatment to obtain a structure containing nanocrystals. With the generation of nanocrystals, good soft magnetic properties can be obtained.

In the soft magnetic alloy including the Fe—Si—B—Cu—Nb alloy, the component composition is adjusted so as to obtain desired properties. For example, elements such as B, C, and P are added from the viewpoint of promoting amorphization necessary for obtaining nanocrystals through heat treatment. In addition, the nanocrystals obtained through the heat treatment can be refined by adding elements such as Cu, Nb, V, Ti, W, Hf, and Ta. In addition, the addition of Si increases magnetic permeability.
Patent Literature 1: JP2011-195936A
Patent Literature 2: JP2019-148004A
Patent Literature 3: JP2019-131853A

### SUMMARY OF INVENTION

The soft magnetic alloy including a Fe—Si—B—Cu—Nb alloy is a material excellent in balance between a coercive force and a saturation magnetic flux density, but is required to have a particularly high saturation magnetic flux density from the viewpoint of miniaturization when used for a high-frequency transformer or the like. In order to improve the saturation magnetic flux density, it is effective to increase the content of Fe or contents of Ni with which a part of Fe can be substituted and Co with which a part of Fe can be substituted. However, in this case, the added amount of the above-described various elements that have an effect on amorphization of the material or refinement of nanocrystals in the nanocrystalline alloy generated by heat treatment is relatively reduced. This makes it difficult to obtain a nanocrystalline alloy containing fine nanocrystals. In particular, when the content of an additive element such as Cu or Nb having a high effect on the refinement of nanocrystals is reduced, the nanocrystals are likely to be coarsened during the heat treatment.

An object of the present invention is to provide a soft magnetic alloy including a Fe—Si—B—Cu—Nb alloy, in which both a high saturation magnetic flux density and refinement of nanocrystals can be achieved, and to provide a method for producing such a soft magnetic alloy.

In order to solve the above problems, a soft magnetic alloy and a method for producing a soft magnetic alloy according to the present invention have the following configurations.

[1]A soft magnetic alloy including, in terms of at %:

$$7. \% \leq Si \leq 12. \% ;$$

$$7. \% \leq B \leq 10. \% ;$$

$$0.5 \% \leq Cu \leq 2. \% ;$$

$$0.5 \% \leq P \leq 2. \% ; and$$

$$3. \% < X \leq 5. \% ,$$

X being at least one element selected from the group consisting of Ti, Nb, V, Zr, Hf, Ta, and W,
with the balance being Fe and unavoidable impurities, or being Fe, at least one selected from the group consisting of Ni with which a part of Fe is substituted and Co with which a part of Fe is substituted, and unavoidable impurities,
in which the soft magnetic alloy satisfies 0.40≤Cu/P<1.0 where Cu and P represent the contents of Cu and P in terms of at %, respectively.

[2] The soft magnetic alloy according to [1] above, further including, in terms of at %:
at least one selected from the group consisting of 0%<Cr≤3.0% and 0%<Mo≤3.0%.

[3] The soft magnetic alloy according to [1] or [2] above, which constitutes a nanocrystalline alloy containing nanocrystals having an average crystal grain size of 30 nm or less.

[4]A method for producing a soft magnetic alloy, the method including:
producing an amorphous alloy ribbon having the component composition according to [1] or [2] above by quenching a molten alloy; and
performing heat treatment on the alloy ribbon at a target temperature, the target temperature being in a range of (a crystallization starting temperature of the alloy ribbon+30° C.)±15° C.

[5] The method for producing a soft magnetic alloy according to [4] above, in which the alloy ribbon is heated at the target temperature for 0.5 hours or longer and 3.0 hours or shorter after a heating temperature is increased to the target temperature at a temperature rise rate of 1° C./min or more and 30° C./min or less.

The soft magnetic alloy according to the present invention having the configuration of the above [1] has the above component composition, so that both a high saturation magnetic flux density and refinement of nanocrystals are achieved. In particular, the soft magnetic alloy contains Cu and P in a predetermined amount and the content ratio thereof satisfies 0.40≤Cu/P<1.0, so that a high effect of refining the nanocrystals is obtained when an amorphous alloy is subjected to the heat treatment. On the other hand, a content of the element X or the like having the effect of refining the nanocrystals can be restricted to a low level, and accordingly, a relatively large content of Fe (and Ni, Co) can be ensured, and the saturation magnetic flux density can be effectively improved.

Further, when the component composition of the soft magnetic alloy exhibits a high effect on the refinement of nanocrystals, a nanocrystalline alloy containing fine nanocrystals can be obtained even if the conditions during the heat treatment, such as the temperature rise rate, the heating temperature, and the heating time, vary to some extent. That is, it is possible to stably generate fine nanocrystals with high robustness against variations in production conditions such as a temperature rise rate, a heating temperature, a heating time, and the like during the heat treatment, and to improve stability in terms of properties of the soft magnetic alloy.

In the aspect [2] above, at least one of Cr or Mo is added to the soft magnetic alloy. Cr and Mo improve the corrosion resistance of the soft magnetic alloy.

In the aspect [3] above, the soft magnetic alloy constitutes a nanocrystalline alloy containing nanocrystals having an average crystal grain size of 30 nm or less. The nanocrystalline alloy is obtained by subjecting an amorphous alloy to heat treatment, and when the nanocrystal to be formed has an average grain size of 30 nm or less, a high effect of improving soft magnetic properties is obtained. When the soft magnetic alloy has the above component composition, it is possible to obtain a nanocrystalline alloy in which the average grain size of the nanocrystals is restricted to be as small as 30 nm or less with high robustness against the production conditions.

In the method for producing a soft magnetic alloy according to the present invention having the configuration of [4] and [5], the amorphous alloy ribbon obtained as an alloy ribbon having the component composition described in [1] or [2] above is subjected to the heat treatment under predetermined conditions, and a nanocrystalline alloy is obtained through the heat treatment. The soft magnetic alloy has the component composition described in [1] or [2], so that the obtained nanocrystalline alloy achieves both a high saturation magnetic flux density and refinement of nanocrystals as described above. The component composition of the soft magnetic alloy exhibits a high effect on the refinement of nanocrystals, so that a nanocrystalline alloy containing fine nanocrystals can be obtained with high robustness even when the temperature rise rate, the target temperature, and the heating time during the heat treatment are changed within the above ranges.

### DESCRIPTION OF EMBODIMENTS

Hereinafter, a soft magnetic alloy according to an embodiment of the present invention and a method for producing the same will be described in detail. The soft magnetic alloy according to the present embodiment has a predetermined component composition. In the present description, a content of each element is expressed in terms of at %. In addition, the various properties indicate values in the atmosphere at room temperature.

### [Component Composition of Soft Magnetic Alloy]

A soft magnetic alloy according to an embodiment of the present invention contains Si, B, Cu, P and an element X, in the following predetermined amount, with the balance being Fe and unavoidable impurities or being Fe, at least one selected from the group consisting of Ni with which a part of Fe is substituted and Co with which a part of Fe is substituted, and unavoidable impurities. Here, the element X refers to at least one element selected from the group consisting of Ti, Nb, V, Zr, Hf, Ta, and W. Further, Cu and P satisfy a predetermined content ratio.

$$7. \% \leq Si \leq 12. \%$$

Si exhibits effects such as improvement in magnetic permeability, reduction in magnetostriction, and reduction in eddy current loss in the soft magnetic alloy. When the content of Si is set to 7.0%≤Si, these effects can be sufficiently obtained. It is preferable that 8.0%≤Si, and more preferable that 9.0%≤Si.

On the other hand, when Si is contained in a too large amount, the content of Fe (and Ni, Co) in the soft magnetic alloy is relatively reduced. This leads to deterioration in magnetic properties, such as making it difficult to obtain a sufficiently high saturation magnetic flux density. In addition, when Si is contained in a too large amount, the magnetostriction is less likely to be reduced. From the viewpoint of preventing such a situation, the content of Si is set to Si≤12.0%. It is preferable that Si≤11.0%.

$$7. \% \leq B \leq 10. \%$$

B exhibits an effect of amorphizing the soft magnetic alloy before heat treatment. Nanocrystals can be generated by subjecting the amorphous soft magnetic alloy to the heat treatment. From the viewpoint of sufficiently promoting the amorphization of the soft magnetic alloy, the content of B is set to 7.0%≤B. It is preferable that 7.5%≤B, and more preferable that 8.0%≤B.

On the other hand, when a large amount of B is contained in the soft magnetic alloy, a FeB compound is likely to be formed when the amorphous alloy is subjected to heat treatment to form a nanocrystalline alloy. The FeB compound causes the magnetic properties of the soft magnetic alloy to decrease. From the viewpoint of preventing the generation of the FeB compound, the content of B is set to B≤10.0%. It is preferable that B≤9.0%.

$$0.5 \% \leq Cu \leq 2. \%$$

Cu promotes formation of clusters serving as nuclei constituting nanocrystals in the soft magnetic alloy through heat treatment. From the viewpoint of obtaining a sufficient effect of promoting cluster formation, the content of Cu is set to 0.5%≤Cu. It is preferable that 0.6%≤Cu, and more preferable that 0.7%≤Cu.

However, when Cu is excessively added, clusters are coarsened, and the refinement of a crystal containing Fe is rather inhibited. In addition, when Cu is contained in a large amount, the content of Fe (and Ni, Co) in the soft magnetic alloy is relatively reduced. From the viewpoint of preventing these phenomena, the content of Cu is set to Cu≤2.0%. It is preferable that Cu≤1.5%, and more preferable that Cu≤1.2%.

$$0.5 \% \leq P \leq 2. \%$$

P has an effect of preventing coarsening of clusters formed by Cu by coexisting with Cu in the soft magnetic alloy and forming Cu₃P clusters. The Cu₃P clusters are more finely dispersed than the Cu clusters. From the viewpoint of sufficiently improving the effect of Cu₃P cluster formation, the content of P is set to 0.5%≤P. It is preferable that 0.8%≤P, and more preferable that 1.0%≤P.

In contrast, when P is added in a large amount, a FeP compound is likely to be formed when the amorphous alloy is subjected to heat treatment to form a nanocrystalline alloy. The formation of the FeP compound causes a decrease in magnetic properties. From the viewpoint of preventing the generation of the FeP compound, the content of P is set to P≤2.0%. It is preferable that P≤1.6%.

$$0.4 \leq Cu / P < 1.$$

The soft magnetic alloy contains Cu and P in the predetermined amount, respectively, and Cu and P satisfy a predetermined content ratio. That is, 0.40≤Cu/P<1.0 is satisfied when the contents of Cu and P in units of at % are expressed as Cu and P, respectively. It is preferable that 0.40≤Cu/P≤0.8.

When the content of P is too large relative to the content of Cu, that is, when Cu/P is too small, surplus P that does not contribute to the formation of the Cu₃P clusters is generated, the refinement of nanocrystals due to the generation of the Cu₃P clusters is less likely to occur effectively, and the surplus P causes the magnetic properties of the soft magnetic alloy to decrease. However, the occurrence of surplus P can be prevented by setting the content ratio of Cu/P to 0.40≤Cu/P and reducing the content of P relative to the content of Cu. It is preferable that 0.50≤Cu/P, and more preferable that 0.60≤Cu/P.

In contrast, when the amount of P is too small relative to the content of Cu, that is, when Cu/P is too large, the formation of the Cu₃P clusters does not occur sufficiently, and sufficient contribution to promotion of fine dispersion of clusters cannot be obtained. However, an effect of promoting the fine dispersion of clusters by the formation of the Cu₃P clusters can be improved by setting the content ratio of Cu/P to Cu/P<1.0 and ensuring the sufficient content of P relative to the content of Cu. It is preferable that Cu/P<0.90, and more preferable that Cu/P<0.80.

$$3. \% < X \leq 5. \%$$

The soft magnetic alloy according to the present embodiment contains the element X, that is, at least one element selected from the group consisting of Ti, Nb, V, Zr, Hf, Ta, and W, and the total content thereof is set to 3.0%<X≤5.0%. It is preferably set to 3.0%<X≤4.0%. Any one of Ti, Nb, V, Zr, Hf, Ta, and W has an effect of preventing coarsening of nanocrystals and facilitating generation of fine nanocrystals in the soft magnetic alloy. The soft magnetic alloy may contain any one or any kind of the element X. It is particularly preferable to contain Nb.

From the viewpoint of sufficiently obtaining the effect of refining the nanocrystals, the content of the element X in the soft magnetic alloy is set to 3.0%<X. It is preferable that 3.1%≤X, and more preferable that 3.2%≤X.

However, when the element X is added in a large amount, the content of Fe (and Ni, Co) in the soft magnetic alloy is relatively reduced. This leads to deterioration in magnetic properties, such as making it difficult to obtain a sufficiently high saturation magnetic flux density. From the viewpoint of preventing deterioration in magnetic properties, the content of the element X is set to X≤5.0%. When the element X is contained in an amount of 5.0% or less, a sufficiently high effect of preventing coarsening of nanocrystals can be obtained. It is preferable that X≤4.0%.

### Fe, Ni, Co

A soft magnetic alloy according to the embodiment of the present invention contains Si, B, Cu, P and the element X, in the predetermined amount described above, with the balance being Fe and unavoidable impurities or being Fe, at least one selected from the group consisting of Ni with which a part of Fe is substituted and Co with which a part of Fe is substituted, and unavoidable impurities. Similarly to Fe, Ni and Co are magnetic elements. When at least one selected from the group consisting of Ni and Co is added, Fe is substituted with the at least one selected from the group consisting of Ni and Co in the soft magnetic alloy. The addition amounts of Ni and Co are not particularly limited, and are preferably set to Ni≤20% and Co≤20%.

The soft magnetic alloy according to the present embodiment may contain Si, B, Cu, P and at least one selected from the group consisting of Ti, Nb, V, Zr, Hf, Ta, and W, in the predetermined amount, as essential elements in addition to Fe (and Ni, Co). The soft magnetic alloy may further contain at least one selected from the group consisting of Cr, Mo, and C as an optional element in a predetermined amount as shown below. In particular, an embodiment containing at least one of Cr or Mo is preferable.

$$0 \% < Cr \leq 3. \%$$

$$0 \% < Mo \leq 3. \%$$

Cr and Mo contribute to improvement in corrosion resistance when added to the soft magnetic alloy. Cr and Mo exhibit an effect of improving corrosion resistance even when added in a small amount, and therefore, there is no particular lower limit for the content of each of Cr and Mo. However, when the content of each of Cr and Mo is more preferably set to 0.02%≤Cr and 0.02%≤Mo, and is further preferably set to 0.05%≤Cr and 0.05%≤Mo, a high addition effect is obtained. Note that when the content of each Cr and Mo is an amount of less than 0.02%, each of Cr and Mo can be regarded as unavoidable impurity.

In contrast, when Cr or Mo is added in a large amount, the content of Fe (and Ni, Co) in the soft magnetic alloy is relatively reduced. This leads to deterioration in magnetic properties, such as making it difficult to obtain a sufficiently high saturation magnetic flux density. From the viewpoint of preventing deterioration in magnetic properties, the content of each of Cr and Mo is preferably set to Cr≤3.0% and Mo≤3.0%. It is more preferable that Cr≤2.5% and Mo≤2.5%.

$$0 \% < C \leq 1. \%$$

C has an effect of improving punchability when added to the soft magnetic alloy. C exhibits this effect even when added in a small amount, and therefore, there is no particular lower limit for the content of C. However, when the content of C is more preferably set to 0.01%≤C, a high addition effect is obtained. Note that C in an amount of less than 0.01% can be regarded as unavoidable impurity.

In contrast, when C is added in a large amount, a FeC compound is likely to be formed when the amorphous alloy is subjected to heat treatment to form a nanocrystalline alloy. The formation of the FeC compound causes a decrease in magnetic properties. From the viewpoint of preventing the generation of the FeC compound, the content of C is preferably set to C≤1.0%, and the content of C is more preferably set to C≤0.3%.

As described above, the soft magnetic alloy according to the present embodiment contains Si, B, Cu, P and at least one selected from the group consisting of Ti, Nb, V, Zr, Hf, Ta, and W, in the predetermined amounts, with the balance being Fe (and Ni, Co) and unavoidable impurities. The soft magnetic alloy may further contain at least one selected from the group consisting of Cr, Mo, and C in the above predetermined amount as an optional element. The unavoidable impurities are allowed to be contained in a range in which the properties of the soft magnetic alloy such as magnetic properties are not greatly impaired. Specific examples of the unavoidable impurities include Mn<0.10%, Al<0.50%, O<0.05%, N<0.05%, and Mg and Ca of 0.05% or less in total. By allowing the inclusion of impurities within the above content range, it is possible to avoid an increase in production cost due to excessive elimination of the inclusion of impurities in the production of the soft magnetic alloy. Since Al has an effect of reducing eddy current loss, Al may be contained in the soft magnetic alloy in the range of Al<0.50%.

A shape of the soft magnetic alloy according to the present embodiment is not particularly limited and may be any shape. However, it is preferable to take the form of an alloy ribbon. The alloy ribbon may be configured as an amorphous alloy or a nanocrystalline alloy containing nanocrystals. In a method for producing a soft magnetic alloy described later, a nanocrystalline alloy can be obtained by subjecting an amorphous alloy to heat treatment. The properties of the soft magnetic alloy will be described after the method for producing the soft magnetic alloy.

### [Method for Producing Soft Magnetic Alloy]

Here, the method for producing a soft magnetic alloy according to an embodiment of the present invention will be described. Here, the soft magnetic alloy according to an embodiment of the present invention described above is produced as an alloy ribbon.

In the present production method, first, an amorphous alloy ribbon having the component composition described above is produced by quenching a molten alloy. The soft magnetic alloy in a ribbon shape can be produced by, for example, a single-roll liquid quenching method. That is, an alloy ribbon can be obtained by ejecting a molten alloy having a predetermined component composition onto a surface of a copper roll rotating at high speed, and quenching and solidifying the molten alloy. The alloy ribbon is preferably produced in an inert atmosphere such as an Ar atmosphere. The production conditions may be adjusted such that the alloy ribbon to be obtained has a width of about 10 mm to 200 mm and a thickness of about 10 m to 50 m. As the production conditions, for example, a mode in which the molten alloy is heated to a temperature higher than the melting point by 200° C. or more, a difference between an internal pressure of a nozzle for ejecting the molten alloy and an external pressure of a space accommodating the copper roll is set to 1 atm or more, and a gap between the nozzle and the roll is set to 1 mm or less can be exemplified.

As described above, the ribbon-shaped soft magnetic alloy obtained by quenching the molten alloy is amorphous. A nanocrystalline alloy can be obtained by subjecting the amorphous alloy ribbon to heat treatment. The nanocrystalline alloy contains nanocrystals in an amorphous matrix.

When the heat treatment is performed, the amorphous alloy ribbon is heated to a target temperature at a predetermined temperature rise rate, and is held at the target temperature for a predetermined time. The target temperature may be set to a temperature higher than a crystallization starting temperature of the soft magnetic alloy constituting the alloy ribbon by 30° C. Alternatively, the target temperature may have a tolerance in a range of ±15° C. Here, the crystallization starting temperature can be measured by differential scanning calorimetry (DSC). In the range of the component composition of the soft magnetic alloy shown above, the temperature higher than the crystallization starting temperature by 30° C. falls within the range of 465° C. or higher and 500° C. or lower, and thus the target temperature may be set within this range. It is preferable not to heat the alloy ribbon at a temperature higher than 500° C. throughout the entire period of the heat treatment.

The temperature rise rate during the heat treatment may be, for example, 1° C./min or more and 30° C./min or less. The heating time at the target temperature may be, for example, 0.5 hours or longer and 3.0 hours or shorter. In addition, the heat treatment is preferably performed in an inert atmosphere such as an Ar atmosphere. After the heat treatment, the alloy ribbon may be subjected to natural cooling in an inert gas.

### [Properties of Soft Magnetic Alloy]

When the soft magnetic alloy according to the embodiment of the present invention has the above component composition, the soft magnetic alloy has excellent soft magnetic properties such as high magnetic permeability and a high saturation magnetic flux density. At the same time, in the nanocrystalline alloy obtained through the heat treatment for the amorphous alloy, the refinement of the nanocrystals can be achieved. In particular, when the soft magnetic alloy contains Cu and P in the predetermined amounts, and the content ratio of Cu to P is in a range of 0.40≤Cu/P<1.0, a high effect on the refinement of nanocrystals is obtained through the formation of finely dispersed clusters. Therefore, even if the content of the element X such as B or Nb, which exhibits an effect for the refinement of nanocrystals, is restricted to some extent, the refinement of nanocrystals can be sufficiently achieved. When the contents of these elements and Si are restricted so as not to be too large, the content of Fe (and Ni, Co), which is a magnetic element, is sufficiently ensured, and a high saturation magnetic flux density is obtained. As described above, the soft magnetic alloy according to the embodiment of the present invention achieves both a high saturation magnetic flux density and refinement of nanocrystals in a well-balanced manner due to the effect of the component composition.

Further, when the soft magnetic alloy is excellent in the effect of refining nanocrystals due to the component composition, a nanocrystalline alloy containing fine nanocrystals can be obtained with high robustness against the production conditions. That is, even if the production conditions of the soft magnetic alloy vary, including the temperature rise rate, the target temperature, and the heating time during the heat treatment, the nanocrystalline alloy containing fine nanocrystals can be produced. Thus, the production conditions can be easily controlled, and the properties of the soft magnetic alloy to be produced are also stabilized. In particular, when the heat treatment is performed on a large soft magnetic alloy material or a large amount of soft magnetic alloy material, it is difficult to increase the temperature rise rate, but even in this case, it is easy to prevent the coarsening of nanocrystals due to the slow temperature rise rate and to stably obtain good magnetic properties.

In the nanocrystalline alloy obtained through the heat treatment for the amorphous alloy, a small grain size of the nanocrystals is preferable because good soft magnetic properties can be obtained. An average grain size of the nanocrystals in the nanocrystalline alloy obtained through the heat treatment is preferably 30 nm or less, more preferably 25 nm or less, and still more preferably 20 nm or less. The present soft magnetic alloy exhibits high robustness against the heat treatment conditions, so that a nanocrystalline alloy in which fine nanocrystals are generated can be stably obtained through the heat treatment under a wide range of conditions such as the target temperature, the temperature rise rate, and the heating time described above for the production method. In particular, it is preferable to obtain a nanocrystalline alloy having an average crystal grain size of 30 nm or less through a heat treatment in which the target temperature is set to a temperature higher than the crystallization starting temperature by 30° C., the temperature rise rate is 10° C./min, and the heating time is 60 minutes, as employed in the following Examples.

As described above, the soft magnetic alloy according to the present embodiment has a high saturation magnetic flux density, and for example, the saturation magnetic flux density is preferably 1.4 T or more. The soft magnetic alloy exhibits good soft magnetic properties, and for example, the core loss is preferably less than 5.0 W/kg at an applied magnetic flux density of 0.1 T and a frequency of 20 kHz. The saturation magnetic flux density and the core loss are measured in a state of a nanocrystalline alloy obtained by subjecting the amorphous alloy to heat treatment.

### EXAMPLES

Hereinafter, the present invention will be described more specifically with reference to Examples. The present invention is not limited by these Examples.

### [Preparation of Samples]

As soft magnetic alloys according to Examples 1 to 15 and Comparative Examples 1 to 9, alloy ribbons containing the component elements at concentrations shown in Table 1, with the balance being unavoidable impurities and Fe, were prepared. In this case, molten alloys having a predetermined component composition ratio were prepared, and ribbons were produced according to a single-roll liquid quenching method. That is, the molten alloy was ejected onto a surface of a rotating copper roll, and quenched and solidified. The obtained alloy ribbon had a width of 30 mm to 120 mm and a thickness of 10 m to 30 m.

Further, for the samples according to Examples and Comparative Examples, the alloy ribbon produced according to the single-roll liquid quenching method described above was subjected to the heat treatment. At this time, the crystallization starting temperature of the alloy of each sample was measured in advance by DSC, and the target temperature of each sample was set as a temperature higher than the crystallization starting temperature by 30° C. The target temperature was within the range of 465° C. to 500° C. for all samples. In the heat treatment, the alloy ribbon was heated from room temperature to the target temperature set as described above at a temperature rise rate of 10° C./min in a heating furnace under an Ar atmosphere. Then, the alloy ribbon was held at the target temperature for 60 minutes. Thereafter, the heating was stopped, and the alloy ribbon was naturally cooled in the heating furnace. In addition, as Reference Example 1, the same sample as in Example 1 was subjected to heat treatment by two-stage heating in which heating was performed at a target temperature of 450° C. for 60 minutes and heating was further performed at 650° C. for 1 hour, instead of the heat treatment under the above conditions. Regarding a sample for evaluating the saturation magnetic flux density and the core loss, the alloy ribbon produced by the single-roll liquid quenching method described above was cut into a ribbon shape having a width of 5 mm and processed into a toroidal core (outer diameter: 21 mm, inner diameter: 20 mm) wound 30 times, and then, the heat treatment was performed under each of the conditions described above.

### [Evaluation Method]

The soft magnetic alloys produced above were subjected to the following evaluations. The evaluations were performed at room temperature.

### (1) Checking of Amorphization

The alloy ribbon before the heat treatment was subjected to X-ray diffraction to check whether the structure was amorphized. Specifically, X-ray diffraction measurement was performed by radiating X-rays to a free surface (a surface not in contact with the roll during quenching) of the alloy ribbon before heat treatment. Cu Ka rays were used as an X-ray source. In the obtained diffraction patterns, the crystallinity (A_{cry}/(Aₐₘₒ+A_{cry})×100%) was calculated based on the integrated intensity (A_{cry}) of peaks derived from a crystalline phase (a phase) and the integrated intensity (Aₐₘₒ) of peaks derived from an amorphous phase. In the case where the obtained crystallinity was less than 5%, it was determined that the amorphization was sufficient (A). On the other hand, in the case where the crystallinity was 5% or more, it was determined that the amorphization was insufficient (B). Here, a peak corresponding to a (220) plane of the a phase was used as the peak derived from the crystalline phase, and a peak having a diffraction angle 2θ satisfying 300≤2θ≤600 and a full width at half maximum≥3° was used as the peak derived from the amorphous phase.

### (2) Crystal Grain Size

The alloy ribbon after the heat treatment was subjected to X-ray diffraction measurement in the same manner as in the test of (1) above. In the obtained X-ray diffraction pattern, an average grain size of the crystal grains was calculated based on the width of the peak corresponding to a (110) plane of the a phase using the Scherrer equation below.

$$D = K λ / B cos θ$$

Here, D represents a crystal grain size. K represents a Scherrer constant, and was set to 0.9. λ represents the wavelength of the X-ray, B represents the width of the diffraction peak, and θ represents the Bragg angle.

When the average crystal grain size is 30 nm or less, it can be considered that the refinement of nanocrystals is sufficiently achieved.

### (3)-Saturation Magnetic Flux Density

The saturation magnetic flux density of the toroidal core after the heat treatment was measured. Specifically, a B-H curve at the maximum magnetic field Hm=3,000 A/m was acquired by performing DC B-H measurement, and the value of the magnetic flux density at H=3,000 A/m was recorded as the saturation magnetic flux density (Bs). When the measured value is 1.4 T or more, the saturation magnetic flux density can be considered to be sufficiently high.

### (4) Core Loss

The core loss of the toroidal core after the heat treatment was measured. Specifically, AC B-H measurement was performed, and the core loss was evaluated at an applied magnetic flux density of 0.1 T and a frequency of 20 kHz. When the measured value is less than 5.0 W/kg, the core loss can be considered to be sufficiently small.

### [Test Results]

Table 1 shows the component compositions and the results of the evaluations for Examples 1 to 15, Comparative Examples 1 to 9, and Reference Example 1. As the component composition, a content ratio of Cu/P is also shown. In the table, the column indicated by “-” means that no element is contained except for unavoidable impurities. Regarding Mg and Ca, the total amount of Mg and Ca is shown.

TABLE 1

| | Element content [at %] | | | | | | | |
|---|---|---|---|---|---|---|---|---|
| Sample No. | Ni | Co | Si | B | Cu | P | Cu/P | Element X |
| Example 1 | — | — | 8.1 | 7.9 | 0.8 | 1.2 | 0.67 | Nb: 3.4 |
| Example 2 | — | — | 10.2 | 8.3 | 0.9 | 1.1 | 0.82 | Nb: 3.3 |
| Example 3 | — | — | 8.7 | 8.6 | 0.8 | 0.9 | 0.89 | Nb: 3.1 |
| Example 4 | — | — | 9.1 | 8.4 | 0.8 | 1.5 | 0.53 | Nb: 3.2 |
| Example 5 | — | — | 8.2 | 7.7 | 0.7 | 1.3 | 0.54 | Ti: 3.4 |
| Example 6 | — | — | 10.6 | 8.1 | 0.8 | 1.2 | 0.67 | V: 3.9 |
| Example 7 | — | — | 10.8 | 8.6 | 0.9 | 1.1 | 0.82 | Zr: 3.6 |
| Example 8 | — | — | 10.2 | 8.0 | 0.9 | 1.2 | 0.75 | Hf: 3.4 |
| Example 9 | — | — | 10.5 | 8.2 | 1.0 | 1.3 | 0.77 | Ta: 3.3 |
| Example 10 | — | — | 8.6 | 8.3 | 1.1 | 1.3 | 0.85 | W: 3.4 |
| Example 11 | — | — | 7.9 | 8.1 | 0.9 | 1.4 | 0.64 | Nb: 3.5 |
| Example 12 | 5.0 | — | 9.0 | 8.4 | 0.7 | 1.2 | 0.58 | Nb: 3.4 |
| Example 13 | — | 5.0 | 8.5 | 8.8 | 0.8 | 1.4 | 0.57 | Nb: 3.1 |
| Example 14 | — | — | 8.0 | 8.2 | 0.8 | 1.2 | 0.67 | Nb: 3.3 |
| Example 15 | — | — | 8.2 | 8.3 | 0.9 | 1.2 | 0.75 | Nb: 3.1 |
| Comparative Example 1 | — | — | 6.0 | 8.0 | 0.9 | 1.1 | 0.82 | Nb: 3.2 |
| Comparative Example 2 | — | — | 16.0 | 8.1 | 1.0 | 1.2 | 0.83 | Nb: 3.4 |
| Comparative Example 3 | — | — | 8.1 | 6.1 | 0.9 | 1.1 | 0.82 | Nb: 3.2 |
| Comparative Example 4 | — | — | 8.2 | 11.2 | 1.0 | 1.0 | 1.00 | Nb: 3.1 |
| Comparative Example 5 | — | — | 8.1 | 7.8 | 0.4 | 0.8 | 0.50 | Nb: 3.5 |
| Comparative Example 6 | — | — | 8.0 | 8.0 | 0.6 | 1.8 | 0.33 | Nb: 3.3 |
| Comparative Example 7 | — | — | 8.5 | 8.5 | 1.5 | 0.9 | 1.67 | Nb: 3.7 |
| Comparative Example 8 | — | — | 8.0 | 8.3 | 0.8 | 1.2 | 0.67 | Nb: 2.5 |
| Comparative Example 9 | — | — | 8.3 | 8.2 | 0.9 | 1.2 | 0.75 | Nb: 3.0 |
| Reference Example 1 | — | — | 8.1 | 7.9 | 0.8 | 1.2 | 0.67 | Nb: 3.4 |

| | Element content [at %] | | | | | | | |
|---|---|---|---|---|---|---|---|---|
| Sample No. | C | Mn | Cr | Mo | Al | O | N | Mg, Ca |
| Example 1 | <0.01 | <0.02 | <0.02 | <0.02 | <0.02 | <0.03 | <0.03 | <0.03 |
| Example 2 | <0.01 | <0.02 | <0.02 | <0.02 | <0.02 | <0.03 | <0.03 | <0.03 |
| Example 3 | <0.01 | <0.02 | <0.02 | <0.02 | <0.02 | <0.03 | <0.03 | <0.03 |
| Example 4 | <0.01 | <0.02 | <0.02 | <0.02 | <0.02 | <0.03 | <0.03 | <0.03 |
| Example 5 | <0.01 | <0.02 | <0.02 | <0.02 | <0.02 | <0.03 | <0.03 | <0.03 |
| Example 6 | <0.01 | <0.02 | <0.02 | <0.02 | <0.02 | <0.03 | <0.03 | <0.03 |
| Example 7 | <0.01 | <0.02 | <0.02 | <0.02 | <0.02 | <0.03 | <0.03 | <0.03 |
| Example 8 | <0.01 | <0.02 | <0.02 | <0.02 | <0.02 | <0.03 | <0.03 | <0.03 |
| Example 9 | <0.01 | <0.02 | <0.02 | <0.02 | <0.02 | <0.03 | <0.03 | <0.03 |
| Example 10 | <0.01 | <0.02 | <0.02 | <0.02 | <0.02 | <0.03 | <0.03 | <0.03 |
| Example 11 | 0.02 | <0.02 | <0.02 | <0.02 | <0.02 | <0.03 | <0.03 | <0.03 |
| Example 12 | <0.01 | <0.02 | <0.02 | <0.02 | <0.02 | <0.03 | <0.03 | <0.03 |
| Example 13 | <0.01 | <0.02 | <0.02 | <0.02 | <0.02 | <0.03 | <0.03 | <0.03 |
| Example 14 | <0.01 | <0.02 | 2.0 | <0.02 | <0.02 | <0.03 | <0.03 | <0.03 |
| Example 15 | <0.01 | <0.02 | <0.02 | 2.0 | <0.02 | <0.03 | <0.03 | <0.03 |
| Comparative Example 1 | <0.01 | <0.02 | <0.02 | <0.02 | <0.02 | <0.03 | <0.03 | <0.03 |
| Comparative Example 2 | <0.01 | <0.02 | <0.02 | <0.02 | <0.02 | <0.03 | <0.03 | <0.03 |
| Comparative Example 3 | <0.01 | <0.02 | <0.02 | <0.02 | <0.02 | <0.03 | <0.03 | <0.03 |
| Comparative Example 4 | <0.01 | <0.02 | <0.02 | <0.02 | <0.02 | <0.03 | <0.03 | <0.03 |
| Comparative Example 5 | <0.01 | <0.02 | <0.02 | <0.02 | <0.02 | <0.03 | <0.03 | <0.03 |
| Comparative Example 6 | <0.01 | <0.02 | <0.02 | <0.02 | <0.02 | <0.03 | <0.03 | <0.03 |
| Comparative Example 7 | <0.01 | <0.02 | <0.02 | <0.02 | <0.02 | <0.03 | <0.03 | <0.03 |
| Comparative Example 8 | <0.01 | <0.02 | <0.02 | <0.02 | <0.02 | <0.03 | <0.03 | <0.03 |
| Comparative Example 9 | <0.01 | <0.02 | <0.02 | <0.02 | <0.02 | <0.03 | <0.03 | <0.03 |
| Reference Example 1 | <0.01 | <0.02 | <0.02 | <0.02 | <0.02 | <0.03 | <0.03 | <0.03 |

Evaluation results

| | | | Saturation | |
|---|---|---|---|---|
| | | Crystal | magnetic | |
| | | grain | flux | Core |
| | | size | density | loss |
| Sample No. | Amorphization | [nm] | [T] | [W/kg] |
| Example 1 | A | 20 | 1.45 | 1.7 |
| Example 2 | A | 21 | 1.40 | 1.5 |
| Example 3 | A | 24 | 1.43 | 1.9 |
| Example 4 | A | 20 | 1.42 | 1.8 |
| Example 5 | A | 26 | 1.45 | 2.3 |
| Example 6 | A | 28 | 1.40 | 2.5 |
| Example 7 | A | 25 | 1.41 | 2.5 |
| Example 8 | A | 25 | 1.41 | 2.6 |
| Example 9 | A | 26 | 1.42 | 2.7 |
| Example 10 | A | 29 | 1.43 | 2.8 |
| Example 11 | A | 17 | 1.44 | 2.1 |
| Example 12 | A | 21 | 1.45 | 2.0 |
| Example 13 | A | 21 | 1.47 | 1.9 |
| Example 14 | A | 22 | 1.45 | 2.9 |
| Example 15 | A | 21 | 1.44 | 3.0 |
| Comparative Example 1 | A | 20 | 1.49 | 5.3 |
| Comparative Example 2 | A | 19 | 1.30 | 1.9 |
| Comparative Example 3 | B | — | 1.48 | 11.2 |
| Comparative Example 4 | A | 22 | 1.39 | 4.2 |
| Comparative Example 5 | A | 44 | 1.47 | 8.9 |
| Comparative Example 6 | A | 37 | 1.44 | 8.6 |
| Comparative Example 7 | A | 35 | 1.42 | 8.7 |
| Comparative Example 8 | A | 49 | 1.44 | 9.5 |
| Comparative Example 9 | A | 32 | 1.43 | 9.0 |
| Reference Example 1 | A | >100 | 1.40 | >100 |

In Table 1, the soft magnetic alloys of Examples 1 to 15 contain 7.0%≤Si≤12.0%, 7.0%≤B≤10.0%, 0.5%≤Cu≤2.0%, 0.5%≤P≤2.0%, 3.0%<X≤5.0%, with the balance being Fe (and Ni, Co) and unavoidable impurities. The content ratio of Cu/P is 0.40≤Cu/P<1.0. Correspondingly, in any soft magnetic alloy of Example, the alloy ribbon before the heat treatment is amorphized, and a nanocrystalline alloy having an average crystal grain size of 30 nm or less is obtained through the heat treatment. In addition, a saturation magnetic flux density of 1.4 T or more is obtained, and the core loss is restricted to be less than 5.0 W/kg. As described above, both the refinement of the nanocrystals in the nanocrystalline alloy and the high saturation magnetic flux density are achieved. In addition, high soft magnetic properties indicated by a low core loss are obtained.

In Comparative Example 1, the content of Si is too small. Accordingly, the core loss is increased. On the other hand, in Comparative Example 2, the content of Si is too large. Accordingly, the content of Fe is reduced, and a saturation magnetic flux density of 1.4 T or more is not obtained. In Comparative Example 3, the content of B is too small. Correspondingly, an amorphous structure was not obtained in a state before the heat treatment, and a nanocrystalline alloy containing nanocrystals was not obtained even after the heat treatment. Therefore, sufficient soft magnetic properties cannot be obtained, and the core loss increases. On the other hand, in Comparative Example 4, the content of B is too large. Accordingly, as in Comparative Example 2, the content of Fe is reduced, and a saturation magnetic flux density of 1.4 T or more was not obtained.

In Comparative Example 5, the content of Cu is too small. The crystal grain size after the heat treatment exceeds 30 nm. It can be interpreted that this is because the content of Cu was small and clusters having an effect of refining nanocrystals could not be sufficiently formed in the amorphous alloy. The core loss is also increased because the nanocrystals are not sufficiently refined. In Comparative Example 6, Cu/P is too small although the content of Cu is sufficient. On the other hand, Cu/P is too large in Comparative Example 7. In both of Comparative Examples 6 and 7, the crystal grain size after the heat treatment exceeds 30 nm. From these results, it can be said that when Cu/P is not within an appropriate range and Cu and P are not contained in a well-balanced manner, the refinement of nanocrystals by the formation of CuP clusters does not sufficiently and effectively function. In Comparative Examples 6 and 7, the core loss is also increased because refinement of the nanocrystals is not sufficient.

In both Comparative Examples 8 and 9, the content of the element X (Nb) is too small. In these Comparative Examples, the effect of refining the nanocrystals by the element X does not sufficiently work, and thus the grain size of the nanocrystals after the heat treatment exceeds 30 nm. In addition, the core loss is also increased.

In Reference Example 1, although the soft magnetic alloy had the same component composition as in Example 1, the heat treatment was performed in two stages, and the second stage of the heat treatment was performed at a high temperature of 650° C. The soft magnetic alloy according to the embodiment of the present invention exhibits high robustness against heat treatment conditions due to the effect of the component composition, and gives a nanocrystalline alloy containing fine nanocrystals through heat treatment under a wide range of conditions. However, when heat treatment is performed at an extremely high temperature as in Reference Example 1, coarsening of nanocrystals occurs. In Reference Example 1, the core loss was significantly large, but this is considered to be due to the precipitation of the boride accompanying the heat treatment in addition to the coarsening of the nanocrystals. From these results, it can be said that it is preferable to keep the heating temperature during the heat treatment at about 500° C. or lower so as not to be too high. A mode in which the two-stage heat treatment is adopted and particularly the second-stage heat treatment is performed at a high temperature is adopted in Patent Literature 3.

The embodiments and Examples of the present invention have been described above. The present invention is not particularly limited to these embodiments and Examples, and various modifications may be made.

The present application is based on Japanese Patent Application No. 2024-083191 filed on May 22, 2024, and the contents thereof are incorporated herein by reference.

What is claimed is:

1. A soft magnetic alloy comprising, in terms of at %:
$$7. \% \leq Si \leq 12. \% ;$$
$$7. \% \leq B \leq 10. \% ;$$
$$0.5 \% \leq Cu \leq 2. \% ;$$
$$0.5 \% \leq P \leq 2. \% ; and$$
$$3. \% < X \leq 5. \% ,$$
X being at least one element selected from the group consisting of Ti, Nb, V, Zr, Hf, Ta, and W,
with the balance being Fe and unavoidable impurities, or being Fe, at least one selected from the group consisting of Ni with which a part of Fe is substituted and Co with which a part of Fe is substituted, and unavoidable impurities,
wherein the soft magnetic alloy satisfies 0.40≤Cu/P<1.0 where Cu and P represent the contents of Cu and P in terms of at %, respectively.

2. The soft magnetic alloy according to claim 1, further comprising, in terms of at %:
at least one selected from the group consisting of 0%<Cr≤3.0% and 0%<Mo≤3.0%.

3. The soft magnetic alloy according to claim 1, which constitutes a nanocrystalline alloy containing nanocrystals having an average crystal grain size of 30 nm or less.

4. The soft magnetic alloy according to claim 2, which constitutes a nanocrystalline alloy containing nanocrystals having an average crystal grain size of 30 nm or less.

5. The soft magnetic alloy according to claim 1, wherein the soft magnetic alloy satisfies 0.40≤Cu/P≤0.8 where Cu and P represent the contents of Cu and P in terms of at %, respectively.

6. The soft magnetic alloy according to claim 1, comprising, in terms of at %, 3.0%<X≤4.0%.

7. A method for producing a soft magnetic alloy, the method comprising:
producing an amorphous alloy ribbon having the component composition according to claim 1 by quenching a molten alloy; and
performing heat treatment on the alloy ribbon at a target temperature, the target temperature being in a range of (a crystallization starting temperature of the alloy ribbon+30° C.)±15° C.

8. A method for producing a soft magnetic alloy, the method comprising:
producing an amorphous alloy ribbon having the component composition according to claim 2 by quenching a molten alloy; and
performing heat treatment on the alloy ribbon at a target temperature, the target temperature being in a range of (a crystallization starting temperature of the alloy ribbon+30° C.)±15° C.

9. The method for producing a soft magnetic alloy according to claim 7, wherein the alloy ribbon is heated at the target temperature for 0.5 hours or longer and 3.0 hours or shorter after a heating temperature is increased to the target temperature at a temperature rise rate of 1° C./min or more and 30° C./min or less.

10. The method for producing a soft magnetic alloy according to claim 8, wherein the alloy ribbon is heated at the target temperature for 0.5 hours or longer and 3.0 hours or shorter after a heating temperature is increased to the target temperature at a temperature rise rate of 1° C./min or more and 30° C./min or less.
